(19) United States
(12) Patent Application Publication
(10) Pub. No.: US 2024/0219603 A1
(43) Pub. Date: Jul. 4, 2024

(54) SYSTEMS AND METHODS FOR PREDICTING STORMS AND ELECTRICAL DEVICE OUTAGES FROM STORMS

(71) Applicant: AIDash Inc., San Jose, CA (US)

(72) Inventor: Vinay Kyatham, Bengaluru (IN)

(73) Assignee: AIDash Inc., San Jose, CA (US)

(21) Appl. No.: 18/149,043

(22) Filed: Dec. 30, 2022

(51) Int. Cl. G01W 1/10; G06N 3/08

(52) U.S. Cl. CPC G01W 1/10; G06N 3/08

(57) ABSTRACT

An example method includes receiving multiple geographic sub-areas of a geographic area that includes multiple electrical assets of one or more electrical power distribution infrastructures. First weather forecast data from one or more weather forecast services is received and first sets of geographic sub-area weather forecast data are determined based on the first weather forecast data. First sets of features for the multiple geographic sub-areas are identified for an outage prediction deep neural network. First predictions of numbers of electrical asset outages for the multiple geographic sub-areas are generated using the outage prediction deep neural network. The first predictions of the numbers of electrical asset outages are aggregated to obtain a first predicted total number of electrical asset outages for the geographic area. A first report that includes the first predicted total number of electrical asset outages for the geographic area is generated and provided.

### FIELD OF THE INVENTION(S)

Embodiments of the present invention(s) are generally related to predicting weather, and in particular to predicting outages of utility electrical devices that may result from storm damage.

### BACKGROUND

Storms, such as thunderstorms, snowstorms, cyclones, monsoons, and hurricanes, can affect large geographic areas. Within a particular geographic area, there can be a large variation in the types of land (for example, forested, mountainous, or desert) as well as a large variation in the uses of the land (for example, rural, suburban, or urban). Storms may impact various parts of a geographic area differently based on the types of land and how the land is used within the geographic area.

An electrical power distribution utility (“utility”) may distribute electricity to customers within one or more geographic areas. Storms may cause electrical power interruptions to customers of a utility by damaging or otherwise impacting electrical devices of the utility (e.g., electrical power lines, transformers, and/or the like). For example, in the U.S., according to a November 2022 report by the U.S. Energy Information Administration, electricity customers on average may have experienced as many as five hours of electrical power interruptions in 2021 due to storms.

Utilities generally must repair or replace electrical assets that have been damaged or otherwise impacted by storms to restore electrical power to utility customers. In some cases, a utility customer may have to contact the utility to report an electrical power interruption. The utility may then have to map the electrical power interruption to corresponding electrical devices to determine which electrical devices must be repaired or replaced.

### SUMMARY

An example non-transitory computer readable medium comprises executable instructions. The executable instructions are executable by one or more processors to perform a method, the method comprising receiving multiple geographic sub-areas, the multiple geographic sub-areas obtained by a division of a geographic area into the multiple geographic sub-areas, the geographic area including multiple electrical assets of one or more electrical power distribution infrastructures, receiving first weather forecast data from one or more weather forecast services, determining, based on the first weather forecast data, first sets of geographic sub-area weather forecast data, a first set of geographic sub-area weather forecast data including weather forecast data for a geographic sub-area, identifying first sets of features for the multiple geographic sub-areas for an outage prediction deep neural network trained to predict a number of electrical asset outages, a first set of features including a first set of geographic sub-area weather forecast data for a geographic sub-area, a number of the multiple electrical assets in the geographic sub-area, and land use/land cover data for the geographic sub-area, the land use/land cover data including at least one of a first land use/land cover classification and a second land use/land cover classification, generating, at a first time, first predictions of numbers of electrical asset outages for the multiple geographic sub-areas, the generating including providing the first sets of features to the outage prediction deep neural network and receiving from the outage prediction deep neural network the first predictions of the numbers of electrical asset outages for the multiple geographic sub-areas, aggregating the first predictions of the numbers of electrical asset outages for the multiple geographic sub-areas to obtain a first predicted total number of electrical asset outages for the geographic area, and generating and providing a first report, the first report including the first predicted total number of electrical asset outages for the geographic area.

In various embodiments, the method further comprises receiving second weather forecast data from the one or more weather forecast services, determining, based on the second weather forecast data, second sets of geographic sub-area weather forecast data, a second set of geographic sub-area weather forecast data including weather forecast data for a geographic sub-area, identifying second sets of features for the outage prediction deep neural network, a second set of features including a second set of geographic sub-area weather forecast data for a geographic sub-area, the number of the multiple electrical assets in the geographic sub-area, and the land use/land cover data for the geographic sub-area, generating, at a second time subsequent to the first time, second predictions of numbers of electrical asset outages for the multiple geographic sub-areas, the generating including providing the second sets of features to the outage prediction deep neural network and receiving from the outage prediction deep neural network the second predictions of the numbers of electrical asset outages for the multiple geographic sub-areas, aggregating the second predictions of the numbers of electrical asset outages for the multiple geographic sub-areas to obtain a second predicted total number of electrical asset outages for the geographic area, and generating and providing a second report, the second report including the second predicted total number of electrical asset outages for the geographic area.

In various embodiments, the method further comprises generating first lower estimates of the numbers of electrical asset outages and first upper estimates of the numbers of electrical asset outages for the multiple geographic sub-areas, and aggregating the first lower estimates to obtain a first total lower estimated number of electrical asset outages and the first upper estimates to obtain a first total upper estimated number of electrical asset outages, and the first report further includes the first total lower estimated number of electrical asset outages and the first total upper estimated number of electrical asset outages.

In various embodiments, the method further comprises determining, based on the first weather forecast data, first storm characteristics for a storm predicted for the geographic area, the first storm characteristics including at least one of a first storm start time, a first storm peak time, and a first storm end time, each of which is subsequent to the first time, and the first report further includes the first storm characteristics.

In various embodiments, the method further comprises determining, based on the first weather forecast data, third sets of geographic sub-area weather forecast data, a third set of geographic sub-area weather forecast data including weather forecast data for a geographic sub-area, identifying third sets of features for a storm prediction deep neural network trained to predict a storm probability, a third set of features including a third set of geographic sub-area weather forecast data, generating, at a time prior to the first time, storm probabilities for the multiple geographic sub-areas, the generating including providing the third sets of features to the storm prediction deep neural network and receiving from the storm prediction deep neural network the storm probabilities, determining storm categories for the multiple geographic sub-areas based on the storm probabilities, a storm category being one of a high storm damage, a medium storm damage, a low storm damage, and a no storm damage, and generating a map of the multiple geographic sub-areas, the map including visual indications of the storm categories for the multiple geographic sub-areas, and the first report further includes the map.

In various embodiments, the method further comprises determining a geographic area storm category based on the storm categories, wherein the first report further includes the geographic area storm category.

In various embodiments, the method further comprises receiving electrical power distribution infrastructure location data for the one or more electrical power distribution infrastructures, and generating visual indications of the one or more electrical power distribution infrastructures based on the electrical power distribution infrastructure location data, and the map further includes the visual indications of the one or more electrical power distribution infrastructures.

In various embodiments, the method further comprises receiving multiple office areas, the multiple office areas within the geographic area, associating one or more geographic sub-areas of the multiple geographic sub-areas to one or more office areas of the multiple office areas, and aggregating the first predictions of the numbers of electrical asset outages of the multiple geographic sub-areas to obtain first predicted office area numbers of electrical asset outages for the multiple office areas, and the first report further includes the first predicted office area numbers of electrical asset outages.

In various embodiments, the method further comprises receiving vegetation data for the multiple geographic sub-areas, vegetation data for a geographic sub-area including an estimated number of trees in the geographic sub-area and an estimated area of the trees in the geographic sub-area, and the first sets of features for the outage prediction deep neural network further include the vegetation data.

In various embodiments, the method further comprises receiving land use/land cover data for the multiple geographic sub-areas, the land use/land cover data including at least two different land use/land cover classifications, and the first sets of features for the outage prediction deep neural network further include the land use/land cover data.

An example system may comprise at least one processor and memory containing instructions, the instructions being executable by the at least one processor to receive multiple geographic sub-areas, the multiple geographic sub-areas obtained by a division of a geographic area into the multiple geographic sub-areas, the geographic area including multiple electrical assets of one or more electrical power distribution infrastructures, receive first weather forecast data from one or more weather forecast services, determine, based on the first weather forecast data, first sets of geographic sub-area weather forecast data, a first set of geographic sub-area weather forecast data including weather forecast data for a geographic sub-area, identify first sets of features for the multiple geographic sub-areas for an outage prediction deep neural network trained to predict a number of electrical asset outages, a first set of features including a first set of geographic sub-area weather forecast data for a geographic sub-area, a number of the multiple electrical assets in the geographic sub-area, and land use/land cover data for the geographic sub-area, the land use/land cover data including at least one of a first land use/land cover classification and a second land use/land cover classification, generate, at a first time, first predictions of numbers of electrical asset outages for the multiple geographic sub-areas, the generate including to provide the first sets of features to the outage prediction deep neural network and to receive from the outage prediction deep neural network the first predictions of the numbers of electrical asset outages for the multiple geographic sub-areas, aggregate the first predictions of the numbers of electrical asset outages for the multiple geographic sub-areas to obtain a first predicted total number of electrical asset outages for the geographic area, and generate and provide a first report, the first report including the first predicted total number of electrical asset outages for the geographic area.

An example method comprises receiving multiple geographic sub-areas, the multiple geographic sub-areas obtained by a division of a geographic area into the multiple geographic sub-areas, the geographic area including multiple electrical assets of one or more electrical power distribution infrastructures, receiving first weather forecast data from one or more weather forecast services, determining, based on the first weather forecast data, first sets of geographic sub-area weather forecast data, a first set of geographic sub-area weather forecast data including weather forecast data for a geographic sub-area, identifying first sets of features for the multiple geographic sub-areas for an outage prediction deep neural network trained to predict a number of electrical asset outages, a first set of features including a first set of geographic sub-area weather forecast data for a geographic sub-area, a number of the multiple electrical assets in the geographic sub-area, and land use/land cover data for the geographic sub-area, the land use/land cover data including at least one of a first land use/land cover classification and a second land use/land cover classification, generating, at a first time, first predictions of numbers of electrical asset outages for the multiple geographic sub-areas, the generating including providing the first sets of features to the outage prediction deep neural network and receiving from the outage prediction deep neural network the first predictions of the numbers of electrical asset outages for the multiple geographic sub-areas, aggregating the first predictions of the numbers of electrical asset outages for the multiple geographic sub-areas to obtain a first predicted total number of electrical asset outages for the geographic area, and generating and providing a first report, the first report including the first predicted total number of electrical asset outages for the geographic area.

### BRIEF DESCRIPTION OF THE DRAWINGS

FIG. 1 depicts an example environment in which storms and outages may be predicted in some embodiments.

FIG. 2 depicts a block diagram of an example storm and outage predictions system in some embodiments.

FIG. 3 is a flow chart showing a method for receiving and processing data that may be utilized by the storm and outage predictions system in some embodiments.

FIG. 4 depicts a geographic area that has been divided into multiple geographic sub-areas and multiple office areas in some embodiments.

FIG. 5 is a flow chart showing a method for generating and providing a report for storm and outage predictions in some embodiments.

FIG. 6 is a flow chart showing a method for generating storm predictions in some embodiments.

FIG. 7A depicts a table of a feature vector provided to a storm prediction deep neural network for storm prediction in some embodiments.

FIG. 7B depicts an architecture of a storm prediction deep neural network that may be used to perform storm prediction in some embodiments.

FIG. 8 is a flow chart showing a method for generating outage predictions in some embodiments.

FIG. 9A depicts a table of an example feature vector for outage prediction in some embodiments.

FIG. 9B depicts example layers of an example outage prediction deep neural network that may be used to perform outage prediction in some embodiments

FIGS. 10A-10C depict reports for storm and outage predictions for a geographic area that may be generated and provided in some embodiments.

FIG. 11 depicts a report of outage predictions by office area that may be generated and provided in some embodiments.

FIG. 12 depicts a block diagram of an example digital device in some embodiments.

### DETAILED DESCRIPTION

A storm may affect various parts of a geographic area differently. Accordingly, even if a storm is forecasted for a geographic area, it can be difficult to predict how parts of the geographic area may be affected. For example, a windstorm that has high wind speeds may be normal for mountainous or forested parts of a geographic area but may be considered excessive for urban parts. In predicting the effects of a storm on a geographic area, it is advantageous to be able to predict the effects on the various parts of the geographic area.

Generally, a utility has one or more electrical power distribution infrastructures in a served geographic area. When a storm is approaching the geographic area, the utility may expect, based on historical records, to have damage to one or more electrical power distribution infrastructures. The damage may cause electrical power interruptions in the geographic area due to storm damage to electrical assets. Such electrical power interruptions are also referred to as “electrical asset outages” or “outages.” Historically, the utility has not be able to predict the number of outages or where the outages are likely to occur in a geographic area. Accordingly, it would be advantageous to be able to predict, for a given storm likely to occur over a given geographic area, a number of outages (or a range of outages) as well as where such outages are likely to occur.

In some embodiments, a geographic area encompassing one or more electrical power distribution infrastructures may be divided into multiple geographic sub-areas. As described herein, a storm and outage predictions system (SOPS) may provide predictions of the effects of a storm on individual geographic sub-areas. The SOPS may do so by using weather forecast data as inputs to a storm prediction deep neural network (and/or use other analytical techniques) that predicts a storm probability for individual geographic sub-areas. The SOPS may further assign a storm category (for example, no storm, low storm, medium storm, high storm) to an individual geographic sub-area based on the storm probability for the individual geographic sub-area, so that the multiple geographic sub-areas have multiple storm categories. The SOPS may thus predict the effects of a storm on a geographic area at the geographic sub-area level. The SOPS thus provides a utility with more granular information as to where and to what extent a particular storm is likely to impact a geographic area.

Furthermore, the SOPS may provide predictions of outages of electrical assets at the individual geographic sub-area level. In various embodiments, the SOPS may use weather forecast data, electrical asset data, vegetation data, and land use/land cover data as inputs to the outage prediction deep neural network to predict a number of outages of electrical assets for individual geographic sub-areas. The SOPS may also provide lower and upper estimates for an estimated number of electrical asset outages. As a result, the SOPS provides a utility with information as to the number of electrical asset outages that are likely to occur and where such outages may occur. Accordingly, the utility may be better prepared to respond to such outages, thereby potentially reducing the amount of time of electrical power interruptions its customers may experience. Based on this information, utilities may take precautionary action to mitigate possible damage, provide backup operations, ensure redundancies are in place, prepare for an amount of energy consumption, and/or the like to prevent or reduce loss of power.

It will be appreciated that various embodiments for predicting outages correct problems caused by current technology. For example, current technologies deliver power to communities in vast, different geographic areas, however, such technologies are subject to storm damage and previously unpredictable outages. One or more embodiments described herein assess the existing technology (e.g., the assets and the network) in view of storms and geography such that outages are predicted and ameliorative action may be taken.

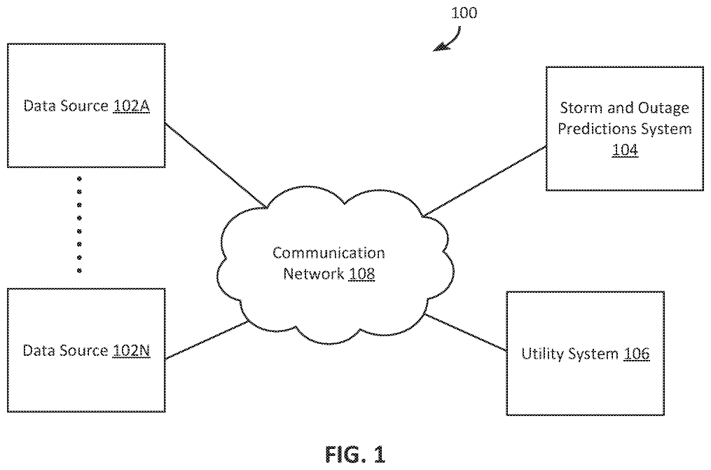

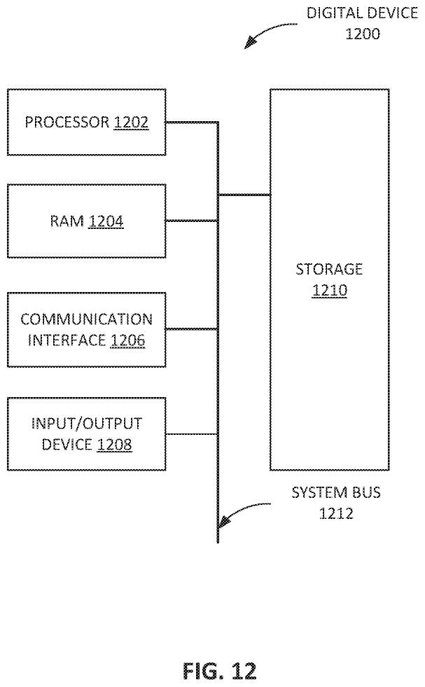

FIG. 1 depicts an example environment 100 in which storms may be predicted and outages of electrical utility devices may be predicted in some embodiments. The example environment 100 includes data sources 102A to 102N (individually, data sources 102 collectively), a communication network 108, a storm and outage predictions system 104 (SOPS 104), and a utility system 106. Each of the SOPS 104 and the utility system 106 may be or include any number of digital devices. A digital device is any device with a processor and memory. Digital devices are further discussed herein (for example, see FIG. 12).

Data sources 102A to 102N may each be a third-party system configured to provide data or access to data. For example, a third-party system operated by a commercial weather data provider such as Spire or Tomorrow.io may be a data source 102. As another example, a third-party system operated by a government weather data provider such as the National Oceanic and Atmospheric Administration (NOAA) may be a data source 102. Data sources 102A to 102N may provide data other than weather data, such as land use/land cover (LULC) data that includes classifications or categorizations of land according to various land use and cover types, such as urban, rural, mountainous and agricultural. Another type of data may be vegetation data, such as that provided by the Intelligent Vegetation Management System (IVMS) of AiDash, the assignee of the present application. Third-party systems operated by other commercial and/or government entities may also be data sources 102.

Any number of the data sources 102A to 102N may provide application programming interfaces (APIs) to enable another system (for example, the SOPS 104) to request data for a particular geographic area. A geographic area is any portion on the surface of the earth. In various embodiments described herein, a geographic area includes assets (for example, electrical network assets).

The utility system 106 may be responsible for the management, control, and/or alerts for one or more electrical power distribution infrastructures. An electrical power distribution infrastructure is any network of electrical generation, transmission and distribution, including electrical assets for the generation, transmission, and distribution of electricity. An electrical asset is any component of the electrical power distribution infrastructure, including, for example, transmission lines, distribution stations, feeder lines, circuit spans, segments, poles, transformers, substations, towers, switches, relays, and/or the like. In some embodiments, the utility system 106 may be a utility company that owns the utility equipment and/or transmission and distribution lines, such as the Pacific Gas and Electricity Company (PG&E). Although FIG. 1 depicts a utility system 106, it will be appreciated that there may not be a utility system 106 but any other system that tracks or enables management of electrical device outages. Further, although FIG. 1 depicts a single utility system 106, it will be appreciated that there can be any number of utility systems 106.

The utility system 106 may provide data regarding one or more electrical power distribution infrastructures and electrical assets in a particular geographic area to the SOPS 104. As described further herein, such data may include, but are not limited to, electrical power distribution infrastructure data and historical outage data.

The storm and outage predictions system 104 (SOPS 104) may be configured to receive weather data, land use/land cover data, and/or vegetation data from data sources 102A-N and electrical power distribution infrastructure data and historical outage data from the utility system 106. As discussed in more detail herein, the SOPS 104 may use such data to train AI models (e.g., deep neural networks) for storm and electrical asset outage predictions.

In some embodiments, communication network 108 represents one or more computer networks (for example, LANs, WANs, and/or the like). The communication network 108 may provide communication between any of the data sources 102, the SOPS 104, and the utility system 106. In some implementations, the communication network 108 comprises computer devices, routers, cables, uses, and/or other network topologies. In some embodiments, the communication network 108 may be wired and/or wireless. In various embodiments, the communication network 108 may comprise the Internet, one or more networks that may be public, private, IP-based, non-IP based, and so forth.

Although electrical power distribution infrastructures are specifically discussed herein, it will be appreciated that embodiments discussed herein may be applied to any infrastructure, including, for example, gas lines, pipelines, buildings, roads, highways, and/or the like.

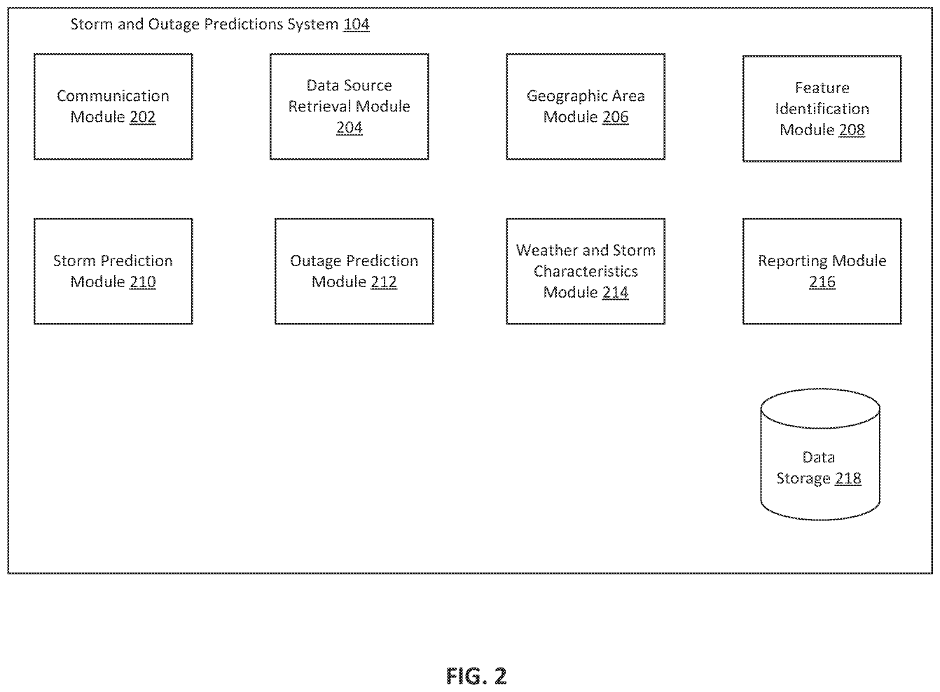

FIG. 2 depicts a block diagram of the SOPS 104 according to some embodiments. The SOPS 104 includes a communication module 202, a data source retrieval module 204, a geographic area module 206, a feature identification module 208, a storm prediction module 210, an outage prediction module 212, a weather and storm characteristics module 214, a reporting module 216, and a data storage 218.

The communication module 202 may send and receive requests or data between any of the data sources 102A-N, the SOPS 104, and the utility system 106. The communication module 202 may receive a request from a user of SOPS 104 (for example, via an interface) to request data from the data sources 102 A-N. In some embodiments, the communication module 202 may provide an interface or information for a remote interface to enable a third party (for example, a utility, vegetation management company, workers, supervisors, contractors, insurance companies, and/or the like) to view and manage electrical asset outage restoration.

In some embodiments, the data source retrieval module 204 may retrieve data from any number of data sources 102A-N (referred to herein as data sources 102). In one example, for weather data, the data source retrieval module 204 may retrieve NOAA HRR data, which may include a real-time 3 km resolution atmospheric model. The data source retrieval module 204 may also retrieve weather data from other sources such as Spire, which has a resolution of 13 km. The data source retrieval module 204 may also retrieve weather data from one or more other sources such as, for example, Tomorrow.io, which has a resolution of 1 km. The data source retrieval module 204 may also retrieve vegetation data from IVMS and electrical power distribution infrastructure data and historical outage data from the utility system 106.

The geographic area module 206 may divide a geographic area into multiple geographic sub-areas, and associate the multiple geographic sub-areas with multiple office areas. The geographic area module 206 may also store and retrieve data regarding the geographic area, the multiple geographic sub-areas, and the multiple office areas in the data storage 218.

The feature identification module 208 may identify sets of features to be provided to a storm prediction deep neural network for storm predictions at the geographic sub-area level. In some embodiments, the feature identification module 208 identifies sets of features to be provided to an outage prediction model (e.g., deep neural network) for outage predictions at the geographic sub-area level. In some embodiments, the feature identification module 208 pre-processes data for features.

The storm prediction module 210 may generate storm predictions for the multiple geographic sub-areas by providing the sets of features identified by the feature identification module 208 to generate storm prediction model(s) (e.g., using a storm prediction deep neural network) for predicting storms at the geographic sub-area level and by receiving the storm probabilities from the storm prediction models. In some embodiments, the storm prediction module 210 categorizes the storm for the multiple geographic sub-areas based on the storm probabilities for the multiple geographic sub-areas and categorizes the storm for the geographic area based on the storm probabilities for the multiple geographic sub-areas.

The outage prediction module 212 may generate outage predictions for the geographic sub-areas by providing the sets of features identified by the feature identification module 208 to an outage prediction architecture to generate models for predicting outages at the geographic sub-area level and by receiving the predictions of numbers of outages of electrical assets in the geographic sub-areas. In some embodiments, the outage prediction module 212 generates lower and upper estimates for numbers of outages of electrical assets in the geographic sub-areas.

In some embodiments, the weather and storm characteristics module 214 determines sets of weather forecast data for multiple geographic sub-areas. In some embodiments, the weather and storm characteristics module 214 determines forecasted characteristics of the storm such as the storm start time, the storm peak time, the storm end time, and the peak wind gust expected.

The reporting module 216 may generate and provide reports that include storm and outage predictions for a geographic area (and the multiple geographic sub-areas) and one or more maps of the geographic area and the multiple geographic sub-areas with visual indications of storm categories for the multiple geographic sub-areas.

In various embodiments, the data storage 218 includes data stored, accessed, and/or modified by any of the modules of the SOPS 104.

A module may be hardware, software, firmware, or any combination. For example, each module may include functions performed by dedicated hardware (e.g., an Application-Specific Integrated Circuit (ASIC), a Field Programmable Gate Array (FPGA), or the like), software, instructions maintained in ROM, and/or any combination.

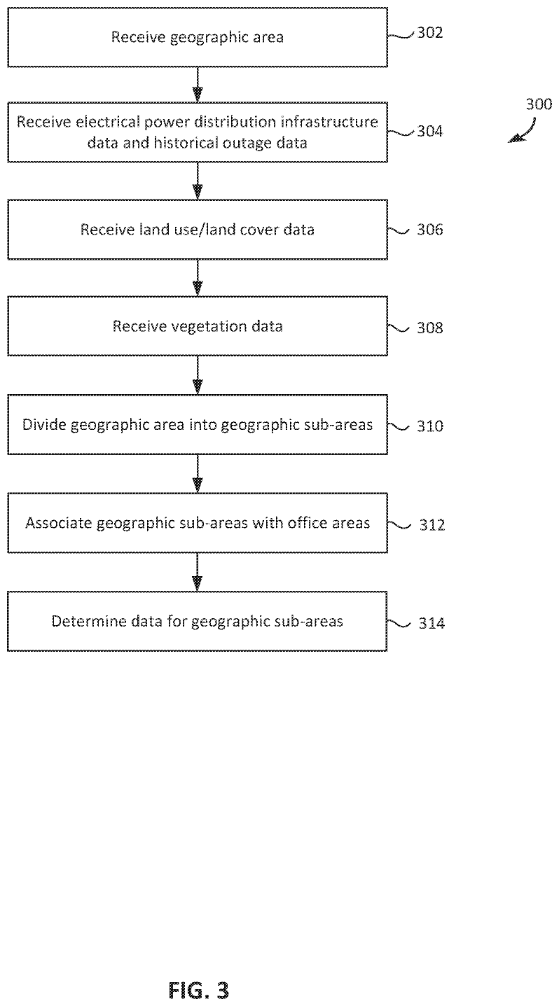

FIG. 3 is a flow chart showing a method 300 for receiving and processing data that may be utilized by the storm and outage predictions system 104 in some embodiments. The method 300 begins with step 302, where the data source retrieval module 204 receives a geographic area from the utility system 106. The geographic area may be an area where the utility system 106 has one or more electrical power distribution assets for delivering electrical power to its customers, which may be businesses, government entities, individual consumers, and the like. The utility system 106 may provide the geographic area in the form of one or more shapefiles to the data source retrieval module 204. The data source retrieval module 204 stores the geographic area, and other data that the data source retrieval module 204 retrieves, in the data storage 218.

At step 304, the data source retrieval module 204 receives data for one or more electrical power distribution infrastructures (e.g., collections of assets, networks, and/or the like) in the geographic area, and data for historical outages that have occurred in the geographic area from the utility system 106. Electrical power distribution infrastructure data may include data on electrical assets such as the device type (transformer, fuse box, etc.), and feeder line data such as voltage and/or phase information and whether the line is a primary or secondary span. Electrical power distribution infrastructure data may further include the locations of electrical assets in the geographic area and a count of the number of electrical assets in the geographic area. Electrical power distribution infrastructure data may further include office area data.

The utility system 106 may have multiple office areas, each of which is responsible for monitoring and responding to electrical asset outages in a specific area within the geographic area. The utility system 106 may provide the electrical power distribution infrastructure in the geographic area in the form of one or more shapefiles to the data source retrieval module 204. Historical outage data may include, for example, data on historical outages of electrical assets such as the time of the electrical asset outage, the location of the electrical asset outage, and the number of downstream customers impacted by the electrical asset outage.

At step 306, the data source retrieval module 204 receives vegetation data from data source 102 for the geographic area. In some embodiments, the data source retrieval module 204 receives vegetation data from the Intelligent Vegetation Management System (IVMS) of AiDash, the assignee of the present application. The vegetation data may include a number of trees in the geographic area, an area of the trees in the geographic area, and an average height of trees in the geographic area. U.S. patent application Ser. No. 17/160,231 filed on Jan. 27, 2021 and entitled “SYSTEM AND METHOD OF INTELLIGENT VEGETATION MANAGEMENT,” describes the IVMS, and is incorporated in its entirety herein by reference.

At step 308 the data source retrieval module 204 receives land use/land cover (LULC) data from data source 102 for the geographic area. The land use/land cover data may specify at least two different land use/land cover classifications for the geographic area. The LULC data may be provided, for example, from government services, open source data sources, and/or any party.

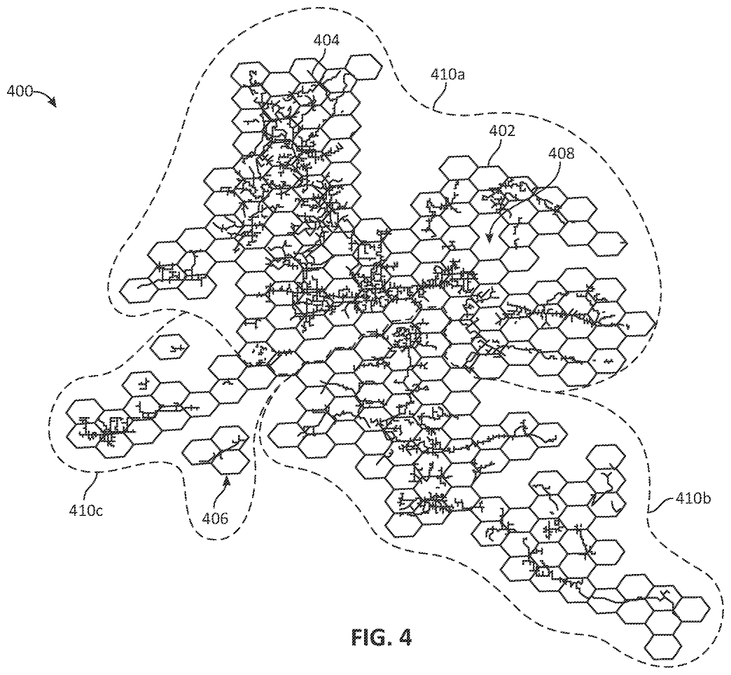

At step 310, the geographic area module 206 divides the geographic area into multiple geographic sub-areas. FIG. 4 depicts a geographic area 400 that has been divided into multiple geographic sub-areas in some embodiments. The geographic area 400 contains one or more electrical power distribution infrastructures. The electrical power distribution infrastructures, such as electrical power distribution infrastructure 404, are shown as solid lines in FIG. 4.

In this example, each geographic sub-area, such as geographic sub-area 402, has a generally hexagonal shape. It will be appreciated that the geographic area module 206 may divide the geographic area into units of consistent shapes (e.g., polygons) and of consistent size. In some embodiments, the geographic area module 206 divides the Geographic area using consistent shapes of consistent size, even if one or more of the geographic sub-areas partially covers an area that is not served by a particular electrical power distribution infrastructure and/or is unrelated to the electrical power distribution infrastructure. In some embodiments, the geographic area module 206 divides the geographic area into consistently sized shapes that tile tightly (e.g., polygons, squares, or triangles). In some embodiments, the geographic area module 206 devices the geographic area into a variety of different shapes. In some embodiments, the geographic area module 206 devices the geographic area into a variety of different sizes. Although in the embodiment depicted, the geographic sub-areas have generally hexagonal shapes, those of skill in the art will understand that the geographic sub-areas may have other polygonal shapes, such as generally square, generally rectangular, etc.

The geographic sub-areas may not be completely contiguous. For example, geographic area 400 includes a grouping of three geographic sub-areas, shown by reference number 406, that are not contiguous with any other geographic sub-areas. Furthermore, the geographic area may have portions where there are no geographic sub-areas, such as the portion shown by reference number 408. Such portions may correspond to parts of the geographic area where the utility system 106 has no electrical assets.

FIG. 4 also depicts three office areas 410, shown individually as office area 410a, office area 410b, and office area 410c (office areas 410 collectively). An office area is a logical association or grouping of one or more geographic sub-areas within the geographic area. The utility system 106 may define the office areas by reference to locations of offices and their areas of responsibility in the event of outages, to facilities for maintenance and repair, and/or the like. Accordingly, an office area 410 may be responsible for one or more geographic sub-areas and thus responsible for monitoring and responding to electrical asset outages in the one or more geographic sub-areas. The office areas may have distinct geographic sub-areas, meaning that a geographic sub-area is in only one office area. Alternatively, a geographic sub-area may be in more than one office area.

Returning to FIG. 3, at step 312 the geographic area module 206 optionally associates the multiple geographic sub-areas with one or more office areas. The geographic area module 206 associates the one or more geographic sub-areas for which an office area is responsible with the office area, and stores that association in data storage 218.

At step 314, the geographic area module 206 determines data for the geographic sub-areas. As the data source retrieval module 204 may receive electrical power distribution infrastructure data, historical outage data, land use/land cover data, and/or vegetation data for the geographic area, there is a need to determine such data for the multiple geographic sub-areas. In addition to the data discussed above, the data received by the geographic area module 206 may include location information (for example, longitude and latitude). Accordingly, the geographic area module 206 may determine a number of historical outages for a geographic sub-area based on the location information and historical outage information. As another example, the geographic area module 206 may determine an urban area percentage, a rural area percentage, a mountain area percentage, and a forest area percentage using the land use/land cover data for a geographic sub-area. As another example, the geographic area module 206 may use the vegetation data to determine a number of trees in a geographic sub-area, an area of the trees in the geographic sub-area, and an average height of trees in the geographic sub-area. Additionally, or alternatively, the data source retrieval module 204 may receive data for individual geographic sub-areas instead of for the geographic area. In such cases, the step 314 of determining data for the geographic sub-areas may be optional.

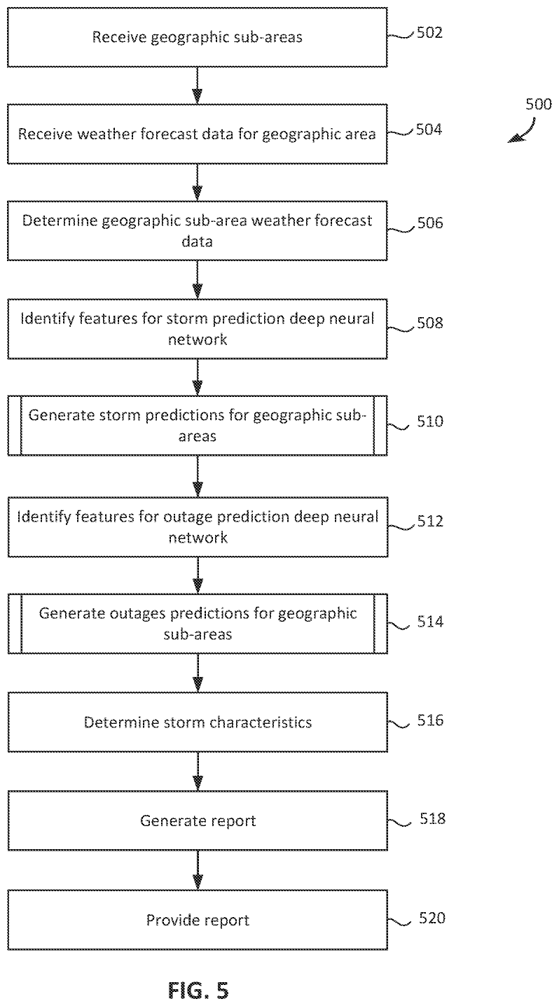

FIG. 5 is a flow chart showing a method 500 for generating and providing a report for storm and outage predictions in some embodiments. The method 500 begins at step 502, where the geographic area module 206 receives the multiple geographic sub-areas, which may occur by the geographic area module 206 accessing the multiple geographic sub-areas in data storage 218. At step 504, the data source retrieval module 204 receives weather forecast data for the geographic area from one or more of the data sources 102, which may be commercial or governmental weather forecast services as discussed herein. The weather forecast data may include, but are not limited to, wind gust in miles per hour (MPH), wind speed in MPH, total precipitation, relative humidity, specific humidity, temperature, dew point temperature, convective available potential energy (CAPE), convective inhibition (CIN), and/or surface pressure. In some embodiments, the weather forecast data also may include leaf area index (LAI) data. The data source retrieval module 204 may receive weather forecast data for various times in the future, such as, for example, 96 hours in the future, 72 hours in the future, 48 hours in the future, 24 hours in the future, 18 hours in the future, 12 hours in the future, and 6 hours in the future. It will be appreciated that the various times in the future may be any amounts or measures of time. The data source retrieval module 204 may receive weather forecast data for any point in the future for which the data sources 102 are able to provide such weather forecast data.

At step 506 the weather and storm characteristics module 214 determines sets of weather forecast data for the multiple geographic sub-areas. A set of weather forecast data is for a geographic sub-area. As previously noted, data sources 102 may provide weather forecast data at various resolutions, such as, for example, 1 km, 3 km, or 13 km. It will be appreciated that the various resolutions may be any amounts or measures. As the weather forecast data has locations associated with it (for example, longitude and latitude), the weather and storm characteristics module 214 is able to use the weather forecast data for the geographic area to determine the weather forecast data for the multiple geographic sub-areas.

At step 508, the feature identification module 208 identifies sets of features that are to be provided to a storm prediction AI/statistical architecture for storm predictions at the geographic sub-area level. The feature identification module 208 identifies a set of features for a geographic sub-area, for the multiple geographic sub-areas, to obtain sets of features for the multiple geographic sub-areas in the geographic area.

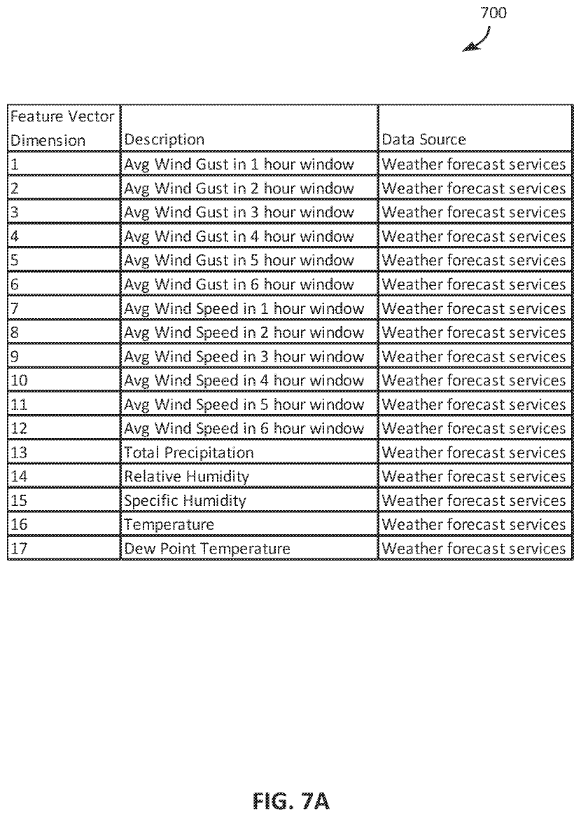

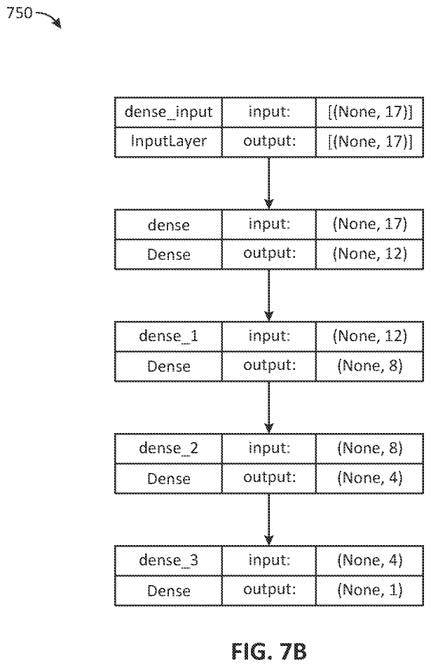

FIG. 7A depicts a table 700 of a feature vector provided to a storm prediction deep neural network for storm prediction in some embodiments. Each dimension of the feature vector is a feature that the feature identification module 208 has identified. There are 17 dimensions to the feature vector, all of which are based on data provided by the weather forecast services. The feature identification module 208 may pre-process certain data to identify a feature vector dimension. For example, the feature identification module 208 may average the maximum wind gusts forecasted by each of the weather forecast services to obtain average maximum wind gusts for various time windows (1 hour, 2 hours, 3 hours, etc.). In some embodiments, the feature identification module 208 may make any statistical measure of wind gusts (e.g., median, mean, or any statistical measure). As another example, the feature identification module 208 may average the wind speeds forecasted by each of the weather forecast services to obtain average wind speeds for various time windows (1 hour, 2 hours, 3 hours, etc.).

In some embodiments, there is an additional dimension to the feature vector, which is a leaf area index (LAI) for the geographic sub-area. The weather forecast services may provide the LAI data to the SOPS 104. In such embodiments, the feature identification module 208 identifies an LAI feature for the geographic sub-area, and the feature vector has 18 instead of dimensions. In some embodiments, the feature identification module 208 may identify other features to be used in the feature vector.

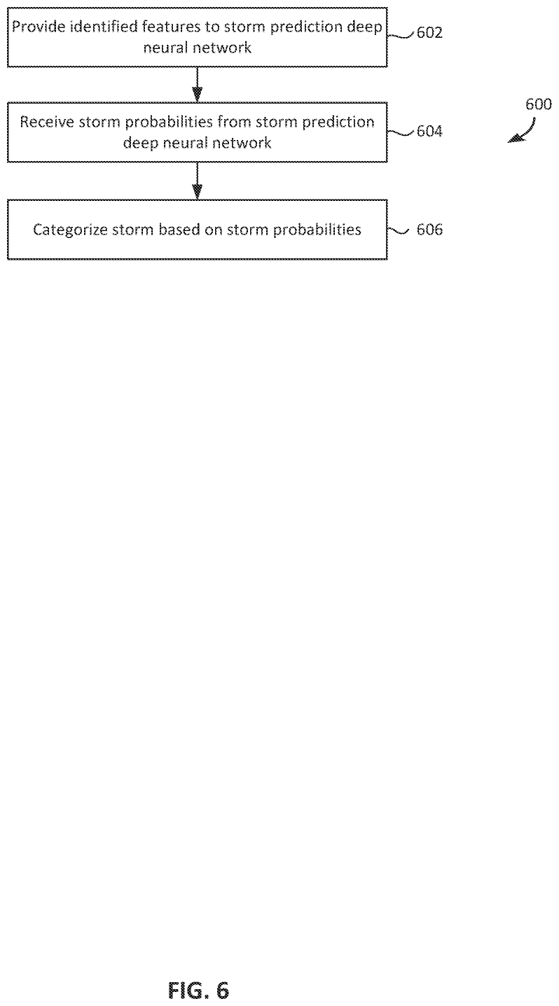

Returning to FIG. 5, at step 510 the storm prediction module 210 generates storm predictions for the multiple geographic sub-areas. FIG. 6 is a flow chart showing a method 600 for generating storm predictions in some embodiments. The method 600 begins at step 602 where the storm prediction module 210 provides the sets of features identified by the feature identification module 208 to a storm prediction deep neural network for predicting storms at the geographic sub-area level.

FIG. 7B depicts an architecture 750 of the storm prediction deep neural network that may be used to perform storm prediction in some embodiments. In this particular example, the storm prediction deep neural network has five layers—an input layer and four dense layers. The input layer has a batch size of None and 17 dimensions, corresponding to the 17 dimensions of the feature vector depicted in table 700 of FIG. 7A. Each layer may output a reduced number of dimensions relative to their particular input (e.g., from 17 to 12 to 8 to 4 to 1). In this example, the last layer provides the output, which is a storm probability for the geographic sub-area. In embodiments where LAI data is an additional dimension of the feature vector, the input layer has 18 dimensions, and the dimensions are reduced layer by layer (from 18 to 12 to 8 to 4 to 1).

While a convolutional neural network (e.g., deep neural network) is depicted in FIG. 7B, it will be appreciated that any neural network (or combination of neural networks) may be utilized. There may be any number of layers and the configurations of each layer depicted in FIG. 7B is one example. In some embodiments, an alternative AI architecture may be utilized (e.g., boosted gradient decision trees, random forest, statistical approaches, and/or the like) that utilize the features discussed herein to generate predictive models and/or make predictions.

In this example, the storm prediction module 210 may train the storm prediction deep neural network on weather forecast data, such as wind gust in MPH, wind speed in MPH, total precipitation, relative humidity, specific humidity, temperature, dew point temperature, convective available potential energy (CAPE), convective inhibition (CIN), and surface pressure, and on historical outage data, such as a time of an outage, a location of an outage, and a number of downstream customers impacted. It will be appreciated that fewer or additional features may be utilized to train the neural network and generate one or more models. Models may be tested and validated based on historical data.

In some embodiments, after a storm, the utility system 106 may provide the SOPS 104 with data on outages of electrical assets that the storm caused. The utility system 106, and/or another data source 102, may also provide the SOPS 104 with storm data, such as measured wind speed, wind gusts, total precipitation, and/or temperature. The storm prediction module 210 may then retrain one or more storm prediction deep neural network(s) and/or models using the “ground truth” of the recently obtained outage data and the storm data. As a result, the models and AI architecture may be updated, improved, and/or curated based on events impacting the particular geographic sub-areas.

Returning to FIG. 6, at step 604, the storm prediction module 210 receives the storm probabilities from the storm prediction deep neural network. At step 606, the storm prediction module 210 assigns storm categories for the multiple geographic sub-areas based on the storm probabilities for the multiple geographic sub-areas. For example, for a geographic sub-area the storm prediction module 210 may assign a storm category as one of no storm (or no storm damage), low storm (or low storm damage), medium storm (or medium storm damage), and high storm (or high storm damage) based on the storm probability for the geographic sub-area.

It will be appreciated that the storm prediction module 210 may assign a value (e.g., probability) and/or quality (e.g., such as a label) for classification associated with a geographic sub-area. In one example, the storm prediction module 210 may assign a value representing a continuum of storm and/or outage intensity. In another example, the storm prediction module 210 may assign a color representing a continuum of storm and/or outage intensity (e.g., green for no damage, orange for medium storm damage and red for high storm damage). It will be appreciated that the storm prediction module 210 may assign and/or provide a classification and/or values for storm prediction and a separate classification and/or values for storm damage.

Returning to FIG. 5, at step 512 the feature identification module 208 identifies sets of features to be provided to an outage prediction deep neural network for outage predictions at the geographic sub-area level. The feature identification module 208 identifies a set of features for a geographic sub-area, for the multiple geographic sub-areas, to obtain sets of features for the multiple geographic sub-areas in the geographic area. There may be any number of features. Each feature may be received from one or more data sources and/or processed to create a new feature based on information from the one or more data sources.

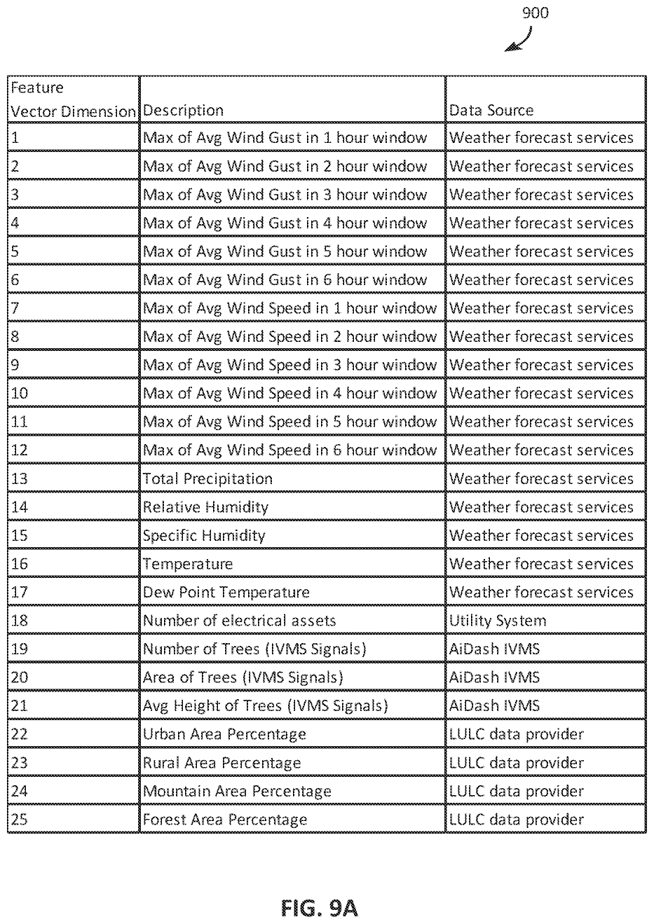

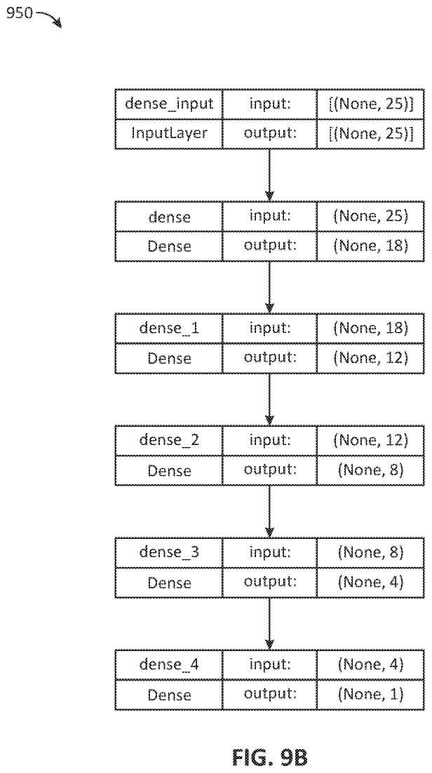

FIG. 9A depicts a table 900 of an example feature vector provided to the outage prediction deep neural network for outage prediction in some embodiments. Each dimension of the feature vector is a feature that the feature identification module 208 has identified. In this example, there are 25 dimensions to the feature vector. Dimensions 1-17 of this example are based on data provided by the weather forecast services. Dimension 18 of this example is the number of electrical assets in a geographic sub-area, which is based on data provided by the utility system 106. Dimensions 19-21 of this example may be provided by AiDash's IVMS (discussed herein). Dimensions 22-25 of this example are based on land use/land cover (LULC) data provided by a data source 102 that provides LULC data. In some embodiments, there is an additional dimension to the feature vector, which is the leaf area index (LAI) for the geographic sub-area. The LAI may be provided by one or more data sources. In such embodiments, the feature identification module 208 identifies an LAI feature for the geographic sub-area, and the feature vector has 26 instead of 25 dimensions. In some embodiments, the feature identification module 208 may identify other features to be used in the feature vector.

The feature identification module 208 may pre-process certain data to identify a feature vector dimension. For example, the feature identification module 208 may calculate an average of the wind gusts forecasted by each of the weather forecast services to obtain average wind gusts for various time windows (1 hour, 2 hours, 3 hours, etc.). The feature identification module 208 may then use the maximum of the calculated averages as the feature vector dimension for the various time windows. As another example, the feature identification module 208 may calculate an average wind speed forecasted by each of the weather forecast services to obtain average wind speeds for various time windows (1 hour, 2 hours, 3 hours, etc.). The feature identification module 208 may then use the maximum of the calculated averages as the feature vector dimension for the various time windows.

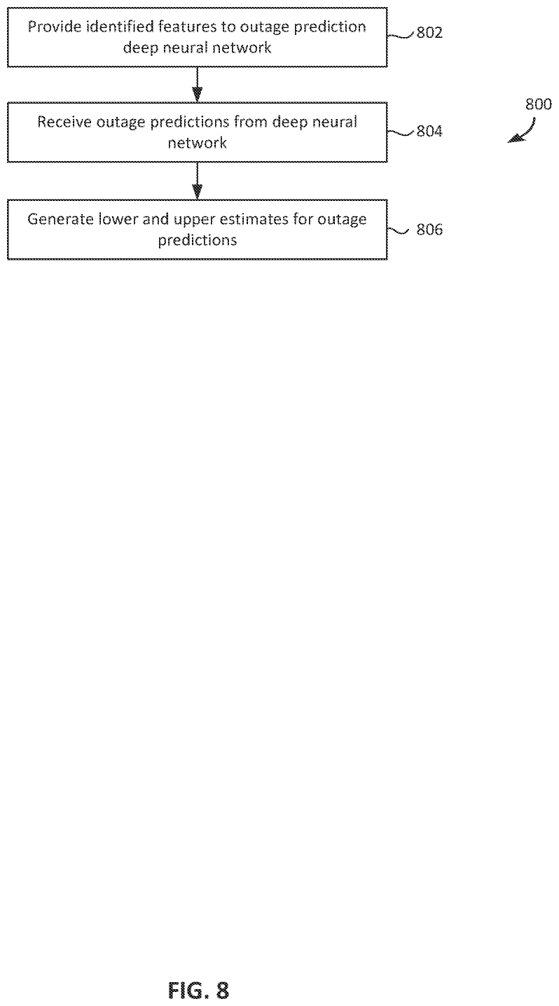

Returning to FIG. 5, at step 514, the outage prediction module 212 generates outage predictions for the geographic sub-areas. FIG. 8 is a flow chart showing a method 800 for generating outage predictions in some embodiments. The method 800 begins at step 802 where the outage prediction module 212 provides the sets of features identified by the feature identification module 208 to an AI architecture, such as the outage prediction deep neural network (discussed herein), for predicting outages at the geographic sub-area level.

FIG. 9B depicts example layers 950 of an example outage prediction deep neural network that may be used to perform outage prediction in some embodiments. The outage prediction deep neural network has six layers—an input layer and five dense layers. The input layer has a batch size of none and 25 dimensions, corresponding to the 25 dimensions of the feature vector. The dimensions are reduced layer by layer (from 25 to 18 to 12 to 8 to 4 to 1). The last layer provides the output, which is a prediction of a number of outages of electrical assets in the geographic sub-area. In embodiments where LAI data is an additional dimension of the feature vector, the input layer has 26 dimensions, and the dimensions are reduced layer by layer (from 26 to 18 to 12 to 8 to 4 to 1).

The outage prediction module 212 may train the outage prediction deep neural network using several types of data. These types include storm probability from the storm prediction deep neural network. These types also include electrical power distribution infrastructure data. Electrical power distribution infrastructure data may include data on electrical assets such as the device type (transformer, fuse box, etc.), feeder line data such as voltage and/or phase information and whether the line is a primary or secondary span. Electrical power distribution infrastructure data may also include office area data. The types of data may also include data on historical outages of electrical assets such as the time of the electrical asset outage, the location of the electrical asset outage, and the number of downstream customers impacted by the electrical asset outage. These types may also include vegetation data, such as the number of trees, height of the trees, area of the trees. These types may also include the land use/land cover (LULC) data.

In some embodiments, after a storm, the utility system 106 may provide the SOPS 104 with data on outages of electrical assets that the storm caused. The utility system 106, and/or another data source 102, may also provide the SOPS 104 with storm data, such as measured wind speed, wind gusts, total precipitation, and/or temperature. The outage prediction module 212 may then retrain the outage prediction deep neural network using the outage data and the storm data.

Returning to FIG. 8, at step 804, the outage prediction module 212 receives the predictions of numbers of outages of electrical assets in the geographic sub-areas from the outage prediction deep neural network. At step 806, the outage prediction module 212 optionally generates lower and upper estimates for numbers of outages of electrical assets in the geographic sub-areas.

Returning to FIG. 5, the method 500 continues at step 516, where the weather and storm characteristics module 214 determines characteristics of the storm for the geographic area using data from the weather forecast services, the storm probability and storm category, and/or the predictions of a number of outages. The weather and storm characteristics module 214 may determine various storm characteristics, such as a predicted storm start time, a predicted storm peak time, a predicted storm end time, and a peak wind gust in MPH. The weather and storm characteristics module 214 may also determine a storm category for the geographic area based on the storm categorizations of the multiple geographic sub-areas. Additionally, or alternatively, the weather and storm characteristics module 214 may determine storm characteristics for office areas. The weather and storm characteristics module 214 may do so by aggregating or otherwise combining weather forecast data, the storm probability and storm category, and/or the predictions of a number of outages, for the geographic sub-areas within office areas.

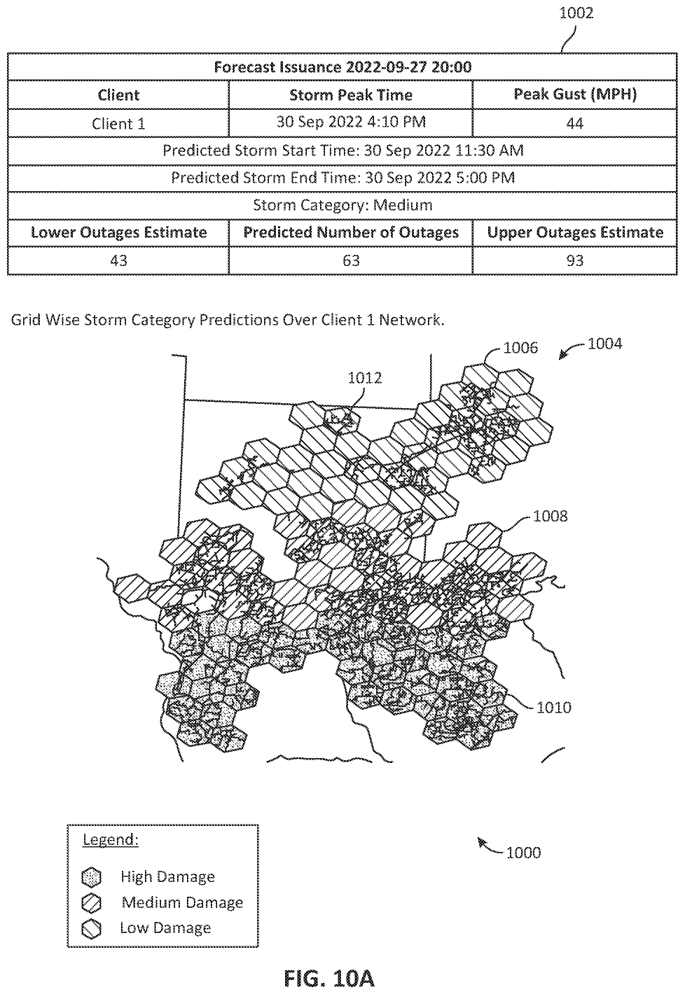

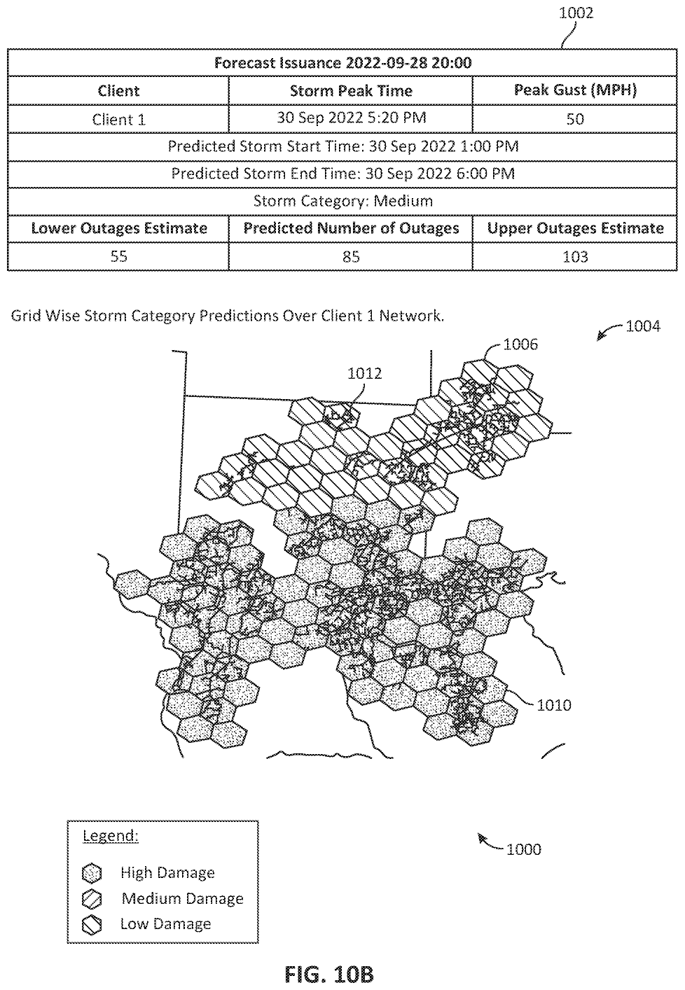

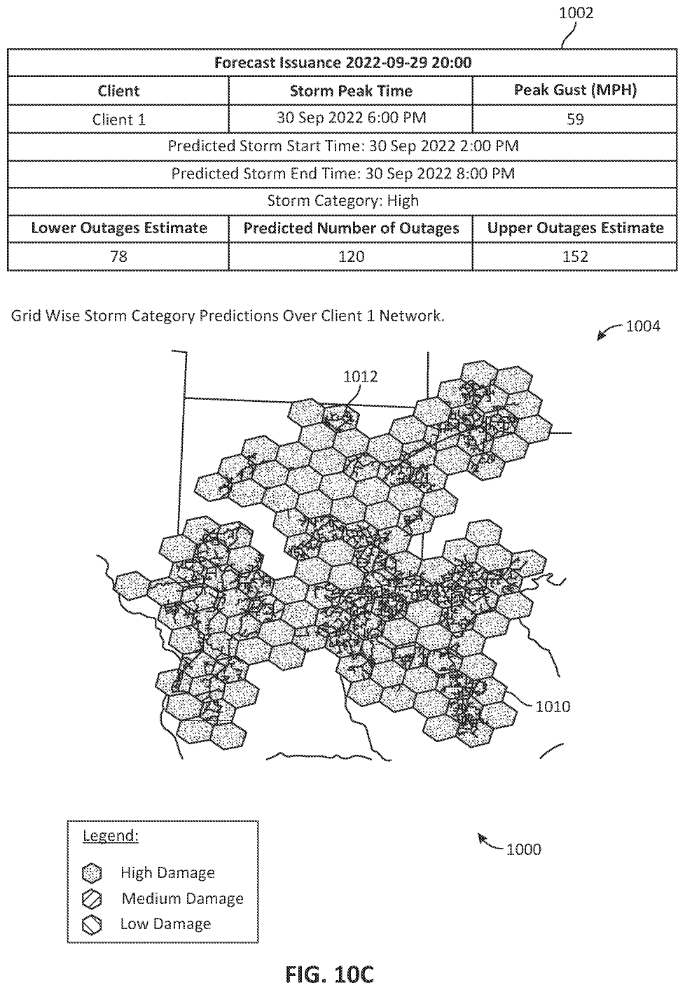

At step 518 the reporting module 216 generates one or more reports. FIGS. 10A-10C depict reports 1000 for storm and outage predictions for a geographic area that may be generated and provided in some embodiments. The reporting module 216 generates the reports 1000. The report 1000 includes a table 1002 and optionally a map 1004 of the geographic area. As discussed further herein, the predicted storm damage and the predicted number of outages for a geographic area may change from report 1000 to report 1000, and FIGS. 10A-10C illustrate such changes.

The example table 1002 includes storm characteristic information and predicted outages information. The storm characteristic information includes storm characteristics such as a predicted storm start time, a predicted storm peak time, and a predicted storm end time. The table 1002 also includes a forecasted peak wind gust in MPH for the geographic area, which may be a maximum of the peak wind gusts forecasted for geographic sub-areas. The example table 1002 also includes a predicted total number of outages for the geographic area, a total lower estimate for the number of outages for the geographic area, and a total upper estimate for the number of outages for the geographic area.

In some embodiments, the reporting module 216 obtains the predicted total number of outages for the geographic area by aggregating the predicted numbers of outages for the multiple geographic sub-areas. The reporting module 216 also aggregates the lower estimates of outages for the multiple geographic areas to obtain the total lower estimate for the number of outages for the geographic area, and aggregates the upper estimates for the multiple geographic areas to obtain the total upper estimate for the number of outages for the geographic area. For example, the reporting module 216 may sum the predicted numbers of outages for the multiple geographic sub-areas to obtain the predicted total number of outages for the geographic area, and may similarly obtain the total lower estimate and the total upper estimate for the geographic area.

The example table 1002 also includes a categorization of the storm for the geographic area, which in FIG. 10A is medium. The map 1004 shows the geographic area and the electrical power distribution infrastructure 1012. The geographic area module 206 has divided the geographic area into multiple geographic sub-areas, and the map 1004 displays the predicted storm categorizations for the multiple geographic sub-areas.

The report 1000 in FIG. 10A is the earliest (e.g., generated chronologically) of the three reports, each report being based on newer information. The reporting module 216 generated the report 1000 approximately 64 hours prior to the predicted storm start time. The map 1004 visually indicates that certain geographic sub-areas, such as the geographic sub-area 1010, have a predicted high damage storm categorization. Other geographic sub-areas, such as geographic sub-area 1008, have a predicted medium damage storm categorization. Other geographic sub-areas, such as geographic sub-area 1006, have a predicted low damage storm categorization.

FIG. 10B illustrates a report 1000 that the reporting module 216 generated approximately 41 hours prior to the predicted storm start time. The storm categorization is still medium, but the map 1004 visually indicates that more of the geographic sub-areas have a predicted high damage storm categorization, such as geographic sub-area 1010. No geographic sub-areas have a medium damage storm categorization, and the same number of geographic sub-areas have a low damage storm categorization, such as geographic sub-area 1006. In addition, the predicted number of outages has climbed from 63 in FIG. 10A to 85, and the lower and upper outages estimates have risen from 43 to 55 and 93 to 103, respectively. Accordingly, the report 1000 in FIG. 10B indicates that the storm is forecast to be more damaging that it was forecast to be at the time the report 1000 in FIG. 10A was generated.

FIG. 10C depicts a report 1000 that the reporting module 216 generated approximately 18 hours prior to the predicted storm start time. The map 1004 visually indicates that all of the geographic sub-areas have a predicted high damage storm categorization. The storm categorization has changed to high, and the predicted number of outages has risen from 85 in FIG. 10B to 120, and the lower and upper outages estimates have risen from 55 to 78 and 103 to 152, respectively. Accordingly, the report 1000 in FIG. 10C indicates that the storm is forecast to be more damaging that it was forecast to be at the time the report 1000 in FIG. 10B was generated.

It will be appreciated that any number of reports may be generated at different times. In some embodiments, the SOPS 104 may occasionally or constantly retrieve information from any number of sources, update predictions when a change (e.g., a delta) of the received information is greater than a particular threshold, and generate new updates (e.g., new reports, new information, new classifications, and/or new numbers of impacted assets).

In some embodiments, the SOPS 104 may generate updated information when a significant change of one or more forecasts is identified (e.g., the change being compared to a threshold) and/or when a new category or greater numbers of impacted equipment is identified (e.g., from output from the AI architecture and compared to a threshold). For example, the SOPS 104 may receive weather forecast data from the weather forecast services that includes a forecast of a more severe storm than an earlier forecast for the geographic area. The SOPS 104 may determine that, due to the more severe forecasted storm, it is appropriate for the SOPS 104 to generate and provide reports at other than the scheduled times. The SOPS 104 may make this determination, for example, by comparing the newer forecast to an earlier forecast. If newer forecasted storm parameters (e.g., wind speed, total precipitation) are higher than earlier forecasted storm parameters by more than one or more threshold values of a threshold, the SOPS 104 may determine that is appropriate to generate updated storm characteristics (e.g., number of outages predicted, regions of impact, updated maps, and the like). In some embodiments, the SOPS 104 may provide an emergency report so that personnel of the utility system 106 may be aware of such changes.

In some embodiments, if the SOPS 104 determines that there is a significant change relative to a previous forecast for the same geographic area (e.g., greater than one or more threshold values of a predetermined threshold), then the SOPS 104 may generate new storm characteristics and/or provide a new report, update an interface (e.g., an app interface on a smart device or a dashboard on a website), and/or provide alerts to users (e.g., individuals associated with the utility). Additionally or alternatively, if the SOPS 104 determines that there is a significant change relative to particular assets (e.g., those that provide critical services and/or are likely to fail) in a particular geographic area (e.g., greater than one or more threshold values of a predetermined threshold), then the SOPS 104 may generate new storm characteristics and/or provide a new report, update an interface (e.g., an app interface on a smart device or a dashboard on a website), and/or provide alerts to users (e.g., individuals associated with the utility).

It will be appreciated that there may be different thresholds for different geographic areas, different geographic sub-areas, and/or different electrical assets. For example, there may be a particular threshold associated with a particular geographic sub-area that includes assets that provide critical services (e.g., to hospitals or large communities) and/or electrical assets that may be at risk (e.g., in need of maintenance and are likely to be impacted by storms). This particular threshold may have a much lower criteria (e.g., more likely to be triggered by smaller changes in forecasts) than another threshold associated with a different geographic sub-area of the same geographic area that does not include assets that provide critical services or have assets that are at risk.

When one or more thresholds indicate a significant change in forecasted storms and/or damage, the SOPS 104 may perform, for example, the method 500 of FIG. 5 to forecast storm categories for one or more of the geographic sub-areas and/or for the geographic area and to determine storm characteristics. In some embodiments, if there are different thresholds associated with different geographic sub-areas, the SOPS 104 may perform the method 500 to forecast storm categories for only the geographic sub-areas that are associated with those thresholds that triggered performing the method. Alternately, if there are different thresholds associated with different geographic sub-areas, the SOPS 104 may perform the method 500 to forecast storm categories for sets of related (e.g., adjacent) geographic sub-areas that are associated with at least one geographic sub-area associated with the threshold that triggered performing the method or the SOPS 104 may perform the method 500 for the larger geographic area.

In some embodiments, a user may configure the SOPS 104 to perform the method per geographic sub-area, sets of geographic sub-areas, and/or the entire geographic region. In some embodiments, the user may configure the SOPS 104 to perform the method 500 for a set or geographic sub-areas when a certain number of thresholds of adjacent geographic sub-areas are exceeded. Similarly, the user may configure the SOPS 104 to perform the method 500 for the entire geographic area when another number (e.g., a higher number) of thresholds of geographic sub-areas are exceeded.

The SOPS 104 may then generate and provide a report 1000 that indicates the updated information. The SOPS 104 may also add language (e.g., “URGENT REPORT” or “Updated Report”) or visual indications to highlight such updated information to personnel of the utility system 106. In some embodiments, the SOPS 104 may provide alerts by email, phone calls, text, app alerts, and/or the like. In various embodiments, a user may configure the SOPS 104 to provide alerts, the way the alerts are to be provided (e.g., email, phone calls, text, app alert's and/or the like).

In some embodiments, the SOPS 104 may trigger alerts or reports if there is a significant change in storm characteristics. For example, the SOPS 104 may periodically or constantly retrieve information from any number of the data sources 102 and generate new storm characteristics for the same geographic area and/or geographic sub-areas. The SOPS 104 may compare the new storm characteristics of a geographic area and/or geographic sub-areas to previously generated storm characteristics for the same region(s) (e.g., based on new, updated weather information of the same coming storm). If the SOPS 104 determines an increase in damage or storm intensity that is greater than one or more different threshold values (e.g., of a threshold), the SOPS 104 may generate an alert and/or report. In some embodiments, if the SOPS 104 determines a decrease in damage or storm intensity that is sufficiently different than one or more different threshold values (e.g., of a threshold), the SOPS 104 may generate an alert and/or report.

Additionally or alternatively to generating and providing reports such as the reports 1000 of FIGS. 10A-C, the SOPS 104 may provide one or more dashboards, accessible via web browsers or device applications, that display the information shown in the table 1002 and/or the map 1004 of the reports 1000. The SOPS 104 may update the one or more dashboards on a periodic or real-time basis as the SOPS 104 receives weather forecast data and generates storm and outages predictions. For example, the SOPS 104 may update all or portions of the map 1004, such as certain geographic sub-areas, as the SOPS 104 generates newer storm and outages predictions. The SOPS 104 may also provide additional information in the one or more dashboards. For example, the SOPS 104 may generate graphs that show the number of forecasted outages over time, for the entire geographic area, for a geographic sub-area, and/or for office areas. Those of ordinary skill in the art will understand that the SOPS 104 may have other ways of presenting storm and outages predictions for a geographic area.

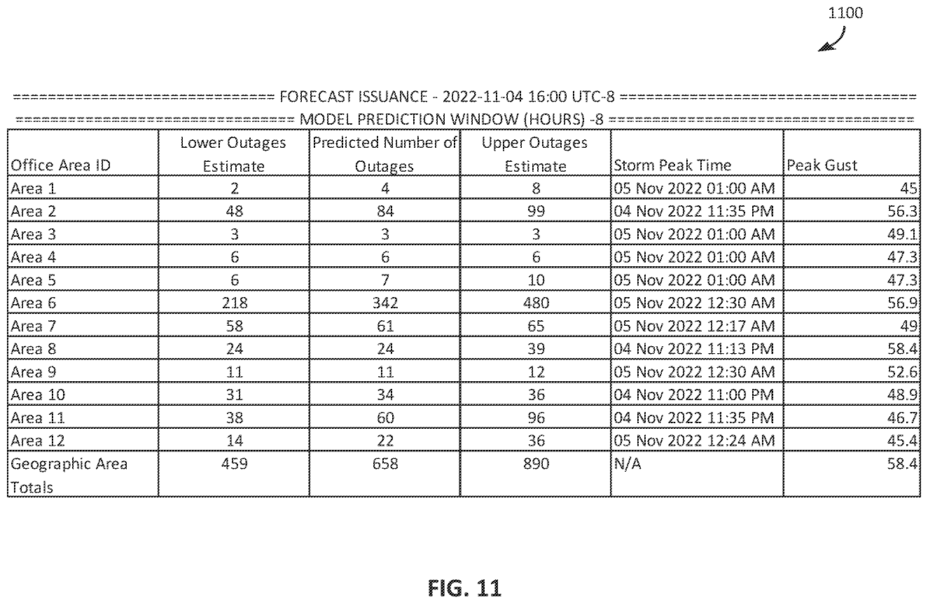

FIG. 11 depicts a report 1100 of outage predictions by office area that may be generated and provided in some embodiments. The reporting module 216 generates the report 1100. The reporting module 216 may generate the report 1100 in addition to or as an alternative to the reports 1000 depicted in FIGS. 10A-C. In the example shown in FIG. 11, the reporting module 216 has generated the report 1100 approximately eight hours prior to the storm start time. The report 1100 includes a list of office areas in a geographic area, and for each office area, a predicted number of outages of electrical assets, a lower estimate of the number of outages of electrical assets, and an upper estimate of the number of outages of electrical assets. The reporting module 216 aggregates the predicted numbers of outages and estimates for the lower and upper bounds for the geographic sub-areas within each office area to obtain the predicted number of outages and the estimates for the lower and upper bounds for the office area. For example, the reporting module 216 may sum the predicted numbers of outages and estimates for the lower and upper bounds for each geographic sub-area within an office area to obtain the predicted number of outages and the estimates for the lower and upper bounds for the office area. The reporting module 216 may use other methods, such as by weighting the predicted numbers and estimates for the geographic sub-areas differently, in aggregating the predicted numbers and estimates for the geographic sub-areas.

The report 1100 also includes, for each office area, a predicted storm peak time and a predicted peak gust. The report 1100 also includes an aggregated number of predicted outages of electrical assets for the geographic area, an aggregated lower estimate of the number of outages of electrical assets for the geographic area, and an aggregated upper estimate of the number of outages of electrical assets for the geographic area. The peak gust for the geographic area is the maximum of the peak gusts predicted for the office areas. In some embodiments, the report 1100 may include other storm characteristic information, such as a storm category for the office area, a predicted storm start time, and/or an amount of precipitation forecasted for the office area.

Returning to FIG. 5, at step 520, the reporting module 216 provides the one or more reports to the utility system 106. The method 500 then concludes. The SOPS 104 may perform the method 500 multiple times as a storm approaches a geographic area. For example, in some embodiments, the SOPS 104 may perform the method 500 at the following times: 96 hours prior to the forecasted storm start time, 72 hours prior to the forecasted storm start time, 48 prior to the forecasted storm start time, 24 hours prior to the forecasted storm start time, 18 hours prior to the forecasted storm start time, 12 hours prior to the forecasted storm start time, and 6 prior to the forecasted storm start time. These times are exemplary, and the SOPS 104 may first perform the method 500 at any point in time prior to the forecasted storm start time, and at any subsequent point in time prior to the forecasted storm start time. The reporting module 216 may generate and provide reports at multiple times during a day, such as at 2 am, 6 am, 2 pm, and 6 pm. These times are exemplary, and the reporting module 216 may generate and provide reports at any time.

One advantage of the method 500 is that it generates and provides reports, such as the reports 1000, that include predictions of how much storm damage may occur in a geographic area on a geographic sub-area level. Accordingly, personnel of the utility system 106 may have a better sense as to what geographic sub-areas they should focus on, and thus be better prepared to respond to damage caused by the storm. Another advantage is that by providing the predicted number of outages and lower and upper estimates, the personnel of the utility system 106 may be able to marshal the appropriate resources (repair workers, equipment, etc.) to respond to outages caused by the storm. Another advantage is that by generating and providing the reports 1000 over time as the storm approaches, the SOPS 104 provides the utility system 106 with updated predictions as to storm damage on the geographic sub-area level and to the number of outages. The utility system 106 can thus adjust resources allocated to respond to outages as the storm approaches.

Another advantage of the method 500 is that it generates and provides reports, such as the report 1100, that include a predicted numbers of outages and lower and upper outages estimates for office areas of a geographic area. By providing a predicted number of outages and lower and upper outages estimates for the office areas, the appropriate personnel for the office area may be better able to prepare to respond to outages of electrical assets in the office areas. The utility system 106 may be able to transfer resources from an office area that is predicted to be affected less than other office areas to other office areas that are predicted to be more affected. Other advantages of the method 500 will be apparent to those of ordinary skill in the art.

FIG. 12 depicts a block diagram of an example digital device 1200 according to some embodiments. Digital device 1200 is shown in the form of a general-purpose computing device. Digital device 1200 includes at least one processor 1202, RAM 1204, communication interface 1206, input/output device 1208, storage 1210, and a system bus 1212 that couples various system components including storage 1210 to the at least one processor 1202.

System bus 1212 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Digital device 1200 typically includes a variety of computer system readable media. Such media may be any available media that is accessible by the SOPS 104 and it includes both volatile and nonvolatile media, removable and non-removable media.

In some embodiments, the at least one processor 1202 is configured to execute executable instructions (for example, programs). In some embodiments, the at least one processor 1202 comprises circuitry or any processor capable of processing the executable instructions.

In some embodiments, RAM 1204 stores data. In various embodiments, working data is stored within RAM 1204. The data within RAM 1204 may be cleared or ultimately transferred to storage 1210.

In some embodiments, communication interface 1206 is coupled to a network via communication interface 1206. Such communication may occur input/output device 1208. Still yet, SOPS 104 can communicate with one or more networks such as a local area network (LAN), a general wide area network (WAN), and/or a public network (for example, the Internet).

In some embodiments, input/output device 1208 is any device that inputs data (for example, mouse, keyboard, stylus) or outputs data (for example, speaker, display, virtual reality headset).

In some embodiments, storage 1210 can include computer system readable media in the form of volatile memory, such as read only memory (ROM) and/or cache memory. Storage 1210 may further include other removable/non-removable, volatile/non-volatile computer system storage media. By way of example only, storage 1210 can be provided for reading from and writing to a non-removable, non-volatile magnetic media. The storage 1210 may include a non-transitory computer-readable medium, or multiple non-transitory computer-readable media, that stores programs or applications for performing functions such as those described herein with reference to, for example, FIG. 2. Although not shown, a magnetic disk drive for reading from and writing to a removable, non-volatile magnetic disk (for example, a “floppy disk”), and an optical disk drive for reading from or writing to a removable, non-volatile optical disk such as a CDROM, DVD-ROM or other optical media can be provided. In such instances, each can be connected to system bus 1212 by one or more data media interfaces. As will be further depicted and described below, storage 1210 may include at least one program product having a set (for example, at least one) of program modules that are configured to carry out the functions of embodiments of the invention. In some embodiments, RAM 1204 is found within storage 1210.

Program/utility, having a set (at least one) of program modules, such as SOPS 104, may be stored in storage 1210 by way of example, and not limitation, as well as an operating system, one or more application programs, other program modules, and program data. Each of the operating system, one or more application programs, other program modules, and program data or some combination thereof, may include an implementation of a networking environment. Program modules generally carry out the functions and/or methodologies of embodiments of the invention as described herein.

It should be understood that although not shown, other hardware and/or software components could be used in conjunction with SOPS 104. Examples include, but are not limited to microcode, device drivers, redundant processing units, and external disk drive arrays, RAID systems, tape drives, and data archival storage systems, etc.

Exemplary embodiments are described herein in detail with reference to the accompanying drawings. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by one skilled in the art, aspects of one or more embodiments may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A transitory computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While specific examples are described above for illustrative purposes, various equivalent modifications are possible, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

1. A non-transitory computer-readable medium comprising executable instructions, the executable instructions being executable by one or more processors to perform a method, the method comprising:
receiving multiple geographic sub-areas, the multiple geographic sub-areas obtained by a division of a geographic area into the multiple geographic sub-areas, the geographic area including multiple electrical assets of one or more electrical power distribution infrastructures;
receiving first weather forecast data from one or more weather forecast services;
determining, based on the first weather forecast data, first sets of geographic sub-area weather forecast data, a first set of geographic sub-area weather forecast data including weather forecast data for a geographic sub-area;
identifying first sets of features for the multiple geographic sub-areas for an outage prediction deep neural network trained to predict a number of electrical asset outages, a first set of features including a first set of geographic sub-area weather forecast data for a geographic sub-area, a number of the multiple electrical assets in the geographic sub-area, and land use/land cover data for the geographic sub-area, the land use/land cover data including at least one of a first land use/land cover classification and a second land use/land cover classification;
generating, at a first time, first predictions of numbers of electrical asset outages for the multiple geographic sub-areas, the generating including providing the first sets of features to the outage prediction deep neural network and receiving from the outage prediction deep neural network the first predictions of the numbers of electrical asset outages for the multiple geographic sub-areas;
aggregating the first predictions of the numbers of electrical asset outages for the multiple geographic sub-areas to obtain a first predicted total number of electrical asset outages for the geographic area; and
generating and providing a first report, the first report including the first predicted total number of electrical asset outages for the geographic area.

2. The non-transitory computer-readable medium of claim 1, the method further comprising:
receiving second weather forecast data from the one or more weather forecast services;
determining, based on the second weather forecast data, second sets of geographic sub-area weather forecast data, a second set of geographic sub-area weather forecast data including weather forecast data for a geographic sub-area;
identifying second sets of features for the outage prediction deep neural network, a second set of features including a second set of geographic sub-area weather forecast data for a geographic sub-area, the number of the multiple electrical assets in the geographic sub-area, and the land use/land cover data for the geographic sub-area;
generating, at a second time subsequent to the first time, second predictions of numbers of electrical asset outages for the multiple geographic sub-areas, the generating including providing the second sets of features to the outage prediction deep neural network and receiving from the outage prediction deep neural network the second predictions of the numbers of electrical asset outages for the multiple geographic sub-areas;
aggregating the second predictions of the numbers of electrical asset outages for the multiple geographic sub-areas to obtain a second predicted total number of electrical asset outages for the geographic area; and
generating and providing a second report, the second report including the second predicted total number of electrical asset outages for the geographic area.

3. The non-transitory computer-readable medium of claim 1, the method further comprising:
generating first lower estimates of the numbers of electrical asset outages and first upper estimates of the numbers of electrical asset outages for the multiple geographic sub-areas; and
aggregating the first lower estimates to obtain a first total lower estimated number of electrical asset outages and the first upper estimates to obtain a first total upper estimated number of electrical asset outages;
wherein the first report further includes the first total lower estimated number of electrical asset outages and the first total upper estimated number of electrical asset outages.

4. The non-transitory computer-readable medium of claim 1, the method further comprising determining, based on the first weather forecast data, first storm characteristics for a storm predicted for the geographic area, the first storm characteristics including at least one of a first storm start time, a first storm peak time, and a first storm end time, each of which is subsequent to the first time, wherein the first report further includes the first storm characteristics.

5. The non-transitory computer-readable medium of claim 1, the method further comprising:
determining, based on the first weather forecast data, third sets of geographic sub-area weather forecast data, a third set of geographic sub-area weather forecast data including weather forecast data for a geographic sub-area;
identifying third sets of features for a storm prediction deep neural network trained to predict a storm probability, a third set of features including a third set of geographic sub-area weather forecast data;
generating, at a time prior to the first time, storm probabilities for the multiple geographic sub-areas, the generating including providing the third sets of features to the storm prediction deep neural network and receiving from the storm prediction deep neural network the storm probabilities;
determining storm categories for the multiple geographic sub-areas based on the storm probabilities, a storm category being one of a high storm damage, a medium storm damage, a low storm damage, and a no storm damage; and
generating a map of the multiple geographic sub-areas, the map including visual indications of the storm categories for the multiple geographic sub-areas,
wherein the first report further includes the map.

6. The non-transitory computer-readable medium of claim 5, the method further comprising determining a geographic area storm category based on the storm categories, wherein the first report further includes the geographic area storm category.

7. The non-transitory computer-readable medium of claim 5, the method further comprising:
receiving electrical power distribution infrastructure location data for the one or more electrical power distribution infrastructures; and
generating visual indications of the one or more electrical power distribution infrastructures based on the electrical power distribution infrastructure location data,
wherein the map further includes the visual indications of the one or more electrical power distribution infrastructures.

8. The non-transitory computer-readable medium of claim 1, the method further comprising:
receiving multiple office areas, the multiple office areas within the geographic area;
associating one or more geographic sub-areas of the multiple geographic sub-areas to one or more office areas of the multiple office areas; and
aggregating the first predictions of the numbers of electrical asset outages of the multiple geographic sub-areas to obtain first predicted office area numbers of electrical asset outages for the multiple office areas,
wherein the first report further includes the first predicted office area numbers of electrical asset outages.

9. The non-transitory computer-readable medium of claim 1, the method further comprising receiving vegetation data for the multiple geographic sub-areas, vegetation data for a geographic sub-area including an estimated number of trees in the geographic sub-area and an estimated area of the trees in the geographic sub-area, wherein the first sets of features for the outage prediction deep neural network further include the vegetation data.

10. The non-transitory computer-readable medium of claim 1, the method further comprising receiving land use/land cover data for the multiple geographic sub-areas, the land use/land cover data including at least two different land use/land cover classifications, wherein the first sets of features for the outage prediction deep neural network further include the land use/land cover data.

11. A system comprising at least one processor; and memory containing instructions, the instructions being executable by the at least one processor to:
receive multiple geographic sub-areas, the multiple geographic sub-areas obtained by a division of a geographic area into the multiple geographic sub-areas, the geographic area including multiple electrical assets of one or more electrical power distribution infrastructures;
receive first weather forecast data from one or more weather forecast services;
determine, based on the first weather forecast data, first sets of geographic sub-area weather forecast data, a first set of geographic sub-area weather forecast data including weather forecast data for a geographic sub-area;
identify first sets of features for the multiple geographic sub-areas for an outage prediction deep neural network trained to predict a number of electrical asset outages, a first set of features including a first set of geographic sub-area weather forecast data for a geographic sub-area, a number of the multiple electrical assets in the geographic sub-area, and land use/land cover data for the geographic sub-area, the land use/land cover data including at least one of a first land use/land cover classification and a second land use/land cover classification;
generate, at a first time, first predictions of numbers of electrical asset outages for the multiple geographic sub-areas, the generate including to provide the first sets of features to the outage prediction deep neural network and to receive from the outage prediction deep neural network the first predictions of the numbers of electrical asset outages for the multiple geographic sub-areas;
aggregate the first predictions of the numbers of electrical asset outages for the multiple geographic sub-areas to obtain a first predicted total number of electrical asset outages for the geographic area; and
generate and provide a first report, the first report including the first predicted total number of electrical asset outages for the geographic area.

12. The system of claim 11, the instructions being further executable by the at least one processor to:
receive second weather forecast data from the one or more weather forecast services;
determine, based on the second weather forecast data, second sets of geographic sub-area weather forecast data a second set of geographic sub-area weather forecast data including weather forecast data for a geographic sub-area;
identify second sets of features for the outage prediction deep neural network, a second set of features including a second set of geographic sub-area weather forecast data for a geographic sub-area, the number of the multiple electrical assets in the geographic sub-area, and the land use/land cover data for the geographic sub-area;
generate, at a second time subsequent to the first time, second predictions of numbers of electrical asset outages for the multiple geographic sub-areas, the generate including to provide the second sets of features to the outage prediction deep neural network and to receive from the outage prediction deep neural network the second predictions of the numbers of electrical asset outages for the multiple geographic sub-areas;
aggregate the second predictions of the numbers of electrical asset outages for the multiple geographic sub-areas to obtain a second predicted total number of electrical asset outages for the geographic area; and
generate and provide a second report, the second report including the second predicted total number of electrical asset outages for the geographic area.

13. The system of claim 11, the instructions being further executable by the at least one processor to:
generate first lower estimates of the numbers of electrical asset outages and first upper estimates of the numbers of electrical asset outages for the multiple geographic sub-areas; and
aggregate the first lower estimates to obtain a first total lower estimated number of electrical asset outages and the first upper estimates to obtain a first total upper estimated number of electrical asset outages;
wherein the first report further includes the first total lower estimated number of electrical asset outages and the first total upper estimated number of electrical asset outages.

14. The system of claim 11, the instructions being further executable by the at least one processor to determine, based on the first weather forecast data, first storm characteristics for a storm predicted for the geographic area, the first storm characteristics including at least one of a first storm start time, a first storm peak time, and a first storm end time, each of which is subsequent to the first time, wherein the first report further includes the first storm characteristics.

15. The system of claim 11, the instructions being further executable by the at least one processor to:
determine, based on the first weather forecast data, third sets of geographic sub-area weather forecast data, a third set of geographic sub-area weather forecast data including weather forecast data for a geographic sub-area;
identify third sets of features for a storm prediction deep neural network trained to predict a storm probability, a third set of features including a third set of geographic sub-area weather forecast data;
generate, at a time prior to the first time, storm probabilities for the multiple geographic sub-areas, the generate including to provide the third sets of features to the storm prediction deep neural network and to receive from the storm prediction deep neural network the storm probabilities;
determine storm categories for the multiple geographic sub-areas based on the storm probabilities, a storm category being one of a high storm damage, a medium storm damage, a low storm damage, and a no storm damage; and
generate a map of the multiple geographic sub-areas, the map including visual indications of the storm categories for the multiple geographic sub-areas,
wherein the first report further includes the map.

16. The system of claim 15, the instructions being further executable by the at least one processor to determine a geographic area storm category based on the storm categories, wherein the first report further includes the geographic area storm category.

17. The system of claim 15, the instructions being further executable by the at least one processor to:
receive electrical power distribution infrastructure location data for the one or more electrical power distribution infrastructures; and
generate visual indications of the one or more electrical power distribution infrastructures based on the electrical power distribution infrastructure location data,
wherein the map further includes the visual indications of the one or more electrical power distribution infrastructures.

18. The system of claim 11, the instructions being further executable by the at least one processor to:
receive multiple office areas, the multiple office areas within the geographic area;
associate one or more geographic sub-areas of the multiple geographic sub-areas to one or more office areas of the multiple office areas; and
aggregate the first predictions of the numbers of electrical asset outages of the multiple geographic sub-areas to obtain first predicted office area numbers of electrical asset outages for the multiple office areas,
wherein the first report further includes the first predicted office area numbers of electrical asset outages.

19. The system of claim 11, the instructions being further executable by the at least one processor to receive vegetation data for the multiple geographic sub-areas, vegetation data for a geographic sub-area including an estimated number of trees in the geographic sub-area and an estimated area of the trees in the geographic sub-area, wherein the first sets of features for the outage prediction deep neural network further include the vegetation data.

20. A method comprising:
receiving multiple geographic sub-areas, the multiple geographic sub-areas obtained by a division of a geographic area into the multiple geographic sub-areas, the geographic area including multiple electrical assets of one or more electrical power distribution infrastructures;
receiving first weather forecast data from one or more weather forecast services;
determining, based on the first weather forecast data, first sets of geographic sub-area weather forecast data, a first set of geographic sub-area weather forecast data including weather forecast data for a geographic sub-area;
identifying first sets of features for the multiple geographic sub-areas for an outage prediction deep neural network trained to predict a number of electrical asset outages, a first set of features including a first set of geographic sub-area weather forecast data for a geographic sub-area, a number of the multiple electrical assets in the geographic sub-area, and land use/land cover data for the geographic sub-area, the land use/land cover data including at least one of a first land use/land cover classification and a second land use/land cover classification;
generating, at a first time, first predictions of numbers of electrical asset outages for the multiple geographic sub-areas, the generating including providing the first sets of features to the outage prediction deep neural network and receiving from the outage prediction deep neural network the first predictions of the numbers of electrical asset outages for the multiple geographic sub-areas;
aggregating the first predictions of the numbers of electrical asset outages for the multiple geographic sub-areas to obtain a first predicted total number of electrical asset outages for the geographic area; and
generating and providing a first report, the first report including the first predicted total number of electrical asset outages for the geographic area.
